(19) United States
(12) Patent Application Publication
(10) Pub. No.: US 2014/0160236 A1
(43) Pub. Date: Jun. 12, 2014

(54) LENSFREE HOLOGRAPHIC MICROSCOPY USING WETTING FILMS

(71) Applicants: Aydogan Ozcan, Los Angeles, CA (US); Waheb Bishara, Menlo Park, CA (US); Onur Mudanyali, Los Angeles, CA (US)

(72) Inventors: Aydogan Ozcan, Los Angeles, CA (US); Waheb Bishara, Menlo Park, CA (US); Onur Mudanyali, Los Angeles, CA (US)

(73) Assignee: THE REGENTS OF THE UNIVERSITY OF CALIFORNIA, Oakland, CA (US)

(21) Appl. No.: 14/235,440

(22) PCT Filed: Jul. 27, 2012
(86) PCT No.: PCT/US2012/048601

§ 371 Date: Jan. 27, 2014

Related U.S. Application Data
(60) Provisional application No. 61/513,391, filed on Jul. 29, 2011.

(51) Int. Cl. G03H 1/08; G06K 9/00; G06T 7/00; G01B 9/021

(52) U.S. Cl. CPC G03H 1/0866; G01B 9/021; G06K 9/00134; G06T 7/0012
USPC 348/40

(57) ABSTRACT

A method of imaging a sample includes forming a monolayer wetting layer over a sample containing objects therein. A plurality of lower resolution images are obtained of the sample interposed between an illumination source and an image sensor, wherein each lower resolution image is obtained at discrete spatial locations. The plurality of lower resolution images of the sample are converted into a higher resolution image. One or more of an amplitude image and a phase image are reconstructed of the objects contained within the sample.

### RELATED APPLICATION

This Application claims priority to U.S. Provisional Patent Application No. 61/513,391, filed on Jul. 29, 2011, which is hereby incorporated by reference in its entirety Priority is claimed pursuant to 35 U.S.C. §119.

### STATEMENT REGARDING FEDERALLY SPONSORED RESEARCH OR DEVELOPMENT

This invention was made with Government support under Grant No. OD006427, awarded by the National Institutes of Health; Grant Nos. 0754880& 0930501 awarded by the National Science Foundation; Grant No. N00014-09-1-0858 awarded by the United States Navy, Office of Naval Research. The Government has certain rights in this invention.

### FIELD OF THE INVENTION

The field of the invention generally relates to imaging systems and methods and more particularly imaging systems that have particular application in the imaging and analysis of small particles such as cells, organelles, cellular particles and the like.

### BACKGROUND

Digital holography has been experiencing a rapid growth over the last several years, together with the availability of cheaper and better digital components as well as more robust and faster reconstruction algorithms, to provide new microscopy modalities that improve various aspects of conventional optical microscopes. In an effort to achieve wide-field on-chip microscopy, the use of unit fringe magnification (F˜1) in lensfree in-line digital holography to claim an FOV of ˜24 mm² with a spatial resolution of <2 μm and an NA of ˜0.1-0.2 has been demonstrated. See Oh C. et al. On-chip differential interference contrast microscopy using lens-less digital holography. Opt Express.; 18(5):4717-4726 (2010) and Isikman et al., Lensfree Cell Holography On a Chip: From Holographic Cell Signatures to Microscopic Reconstruction, Proceedings of IEEE Photonics Society Annual Fall Meeting, pp. 404-405 (2009), both of which are incorporated herein by reference. This recent work used a spatially incoherent light source that is filtered by an unusually large aperture (˜50-100 μm diameter); and unlike most other lens-less in-line holography approaches, the sample plane was placed much closer to the detector chip rather than the aperture plane, i.e., z₁>>z_{z}. This unique hologram recording geometry enables the entire active area of the sensor to act as the imaging FOV of the holographic microscope since F˜1.

More recently, a lensfree super-resolution holographic microscope has been proposed which achieves sub-micron spatial resolution over a large field-of-view of e.g., ˜24 mm². See Bishara et al., “Holographic pixel super-resolution in portable lensless on-chip microscopy using a fiber-optic array,” Lab Chip 11, 1276 (2011), which is incorporated herein by reference. The microscope works based on partially-coherent lensfree digital in-line holography using multiple light sources (e.g., light-emitting diodes—LEDs) placed at ˜3-6 cm away from the sample plane such that at a given time only a single source illuminates the objects, projecting in-line holograms of the specimens onto a CMOS sensor-chip. Since the objects are placed very close to the sensor chip (e.g., ˜1-2 mm) the entire active area of the sensor becomes the imaging field-of-view, and the fringe-magnification is unit. As a result of this, these holographic diffraction signatures are unfortunately under-sampled due to the limited pixel size at the CMOS chip (e.g., ˜2-3 μm). To mitigate this pixel size limitation on spatial resolution, several lensfree holograms of the same static scene are recorded as different LEDs are turned on and off, which creates sub-pixel shifted holograms of the specimens. By using pixel super-resolution techniques, these sub-pixel shifted under-sampled holograms can be digitally put together to synthesize an effective pixel size of e.g., ˜300-400 nm, which can now resolve/sample much larger portion of the higher spatial frequency oscillations within the lensfree object hologram. Unfortunately, the imaging performance of this lensfree microscopy tool is still limited by the detection SNR, which may pose certain limitations for imaging of e.g., weakly scattering phase objects that are refractive index matched to their surrounding medium such as sub-micron bacteria in water.

Wetting thin-film dynamics have been studied in chemistry and biology and attempts have been made to incorporate the same in imaging modalities. Among these prior results, a recent application of thin wetting films towards on-chip detection of bacteria provides an approach where the formation of evaporation-based wetting films was used to enhance e.g., diffraction signatures of bacteria on a chip. See e.g., C. P. Allier et al., Thin wetting film lensless imaging, Proc. SPIE 7906, 760608 (2011). While the promising, this previous approach unfortunately can not reveal microscopic images of the specimens under test, and is therefore quite limited in scope especially for handling heterogeneous or unknown samples, where fine morphological features of the objects need to be microscopically imaged for identification and characterization purposes.

### SUMMARY

In one embodiment of the invention, a method of imaging a sample includes forming a monolayer wetting layer over a sample containing objects therein. A plurality of lower resolution images are obtained of the sample interposed between an illumination source and an image sensor, wherein each lower resolution image is obtained at discrete spatial locations. The plurality of lower resolution images of the sample are converted into a higher resolution image. One or more of an amplitude image and a phase image are reconstructed of the objects contained within the sample.

In another embodiment of the invention, the method of imaging a sample includes forming a monolayer wetting layer over a sample containing objects therein. The sample is interposed between an illumination source and an image sensor. The sample is illuminated with the illumination source and an image of the sample is obtained with the image sensor.

### BRIEF DESCRIPTION OF THE DRAWINGS

FIG. 1A schematically illustrates a system for imaging an object within a sample.

FIG. 1B illustrates a sample holder containing a sample (and objects) thereon.

FIG. 1C illustrates a system for imaging an object according to one embodiment that uses two-dimensional aperture shifting.

FIG. 2 illustrates a side view of a sample holder containing a wetting film monolayer that contains objects therein.

FIG. 3 illustrates an embodiment of forming a wetting film monolayer on a sample holder according to one embodiment.

FIG. 4 illustrates a top-level flowchart of how the system obtains higher resolution pixel Super Resolution (Pixel SR) images of objects within a sample.

FIGS. 5A, 5B, and 5C illustrate the improved imaging performance as a result of the use of wetting films to image Giardia lamblia trophozoites (FIG. 5A), E. Coli (FIG. 5B), and human RBCs (FIG. 5C).

FIGS. 6A and 6B show images comparing imaging performance with and without the presence of a wetting film. FIG. 6A shows various images obtained without a wetting film while FIG. 6B shows various images obtained with a wetting film.

FIG. 7A illustrates a wetting film Super Resolved amplitude image of a sperm cell at a depth of 794 μm.

FIG. 7B illustrates a wetting film Super Resolved phase image of a sperm cell at a depth of 794 μm.

FIG. 7C illustrates a wetting film Super Resolved amplitude image of a sperm cell at a depth of 778 μm.

FIG. 7D illustrates a wetting film Super Resolved phase image of a sperm cell at a depth of 778 μm.

FIG. 8A illustrates a panel of images (no wetting film) that includes a SR hologram, SR reconstruction image, and 60× objective view of a 1 μm diameter bead.

FIG. 8B illustrates a panel of images (no wetting film) that includes a SR hologram, SR reconstruction image, and 60× objective view of an E coli bacterium.

FIG. 8C illustrates a panel of images (obtained with a wetting film) that includes a WSR hologram, WSR reconstruction image, and 60× objective view a 1 μm diameter bead.

FIG. 8D illustrates a panel of images (obtained with a wetting film) that includes a WSR hologram, WSR reconstruction image, and 60× objective view an E coli bacterium.

FIG. 9 illustrates a full field-of-view (i.e., 24 mm²) lensfree holographic image of a spiked wetting film sample that is composed of Giardia lamblia trophozoites, E. coli and sperm samples.

### DETAILED DESCRIPTION OF THE ILLUSTRATED EMBODIMENTS

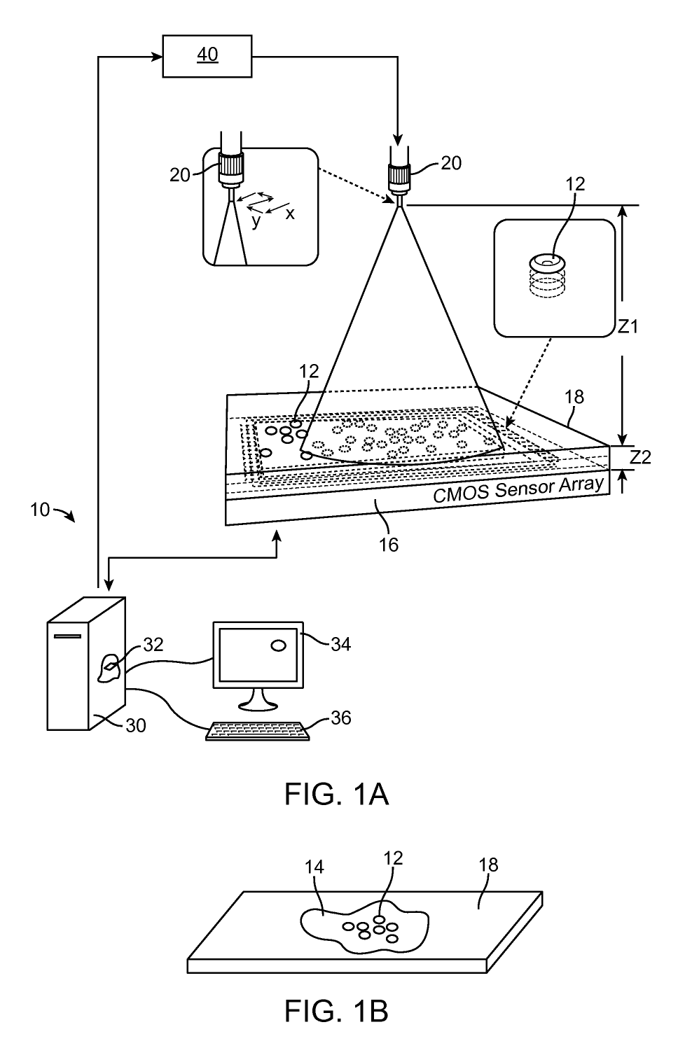

FIG. 1A illustrates a system 10 for imaging of an object 12 (or more preferably multiple objects 12) within a sample 14 (best seen in FIG. 1B). The object 12 may include a cell or biological component or constituent (e.g., a cellular organelle or substructure). The object 12 may even include a multicellular organism or the like. For example, the object 12 may be a blood cell (e.g., red blood cell (RBC), white blood cell), bacteria, protozoa, or viruses. Alternatively, the object 12 may be a particle or other object. Generally, particles or objects having a size within the range of about 0.05 μm to about 500 μm may be imaged with the system 10. FIG. 1A illustrates objects 12 in the form of red blood cells (RBCs) to be imaged that are disposed some distance z₂ above an image sensor 16. As explained herein, this distance z₂ is adjustable as illustrated by the Δz in the inset of FIG. 1A. The sample 14 containing one or more objects 12 is typically placed on a optically transparent sample holder 18 such as a glass or plastic slide, coverslip, or the like as seen in FIG. 1B.

The surface of image sensor 16 may be in contact with or close proximity to the sample holder 18. Generally, the objects 12 within the sample 14 are located within several millimeters within the active surface of the image sensor 16. The image sensor 16 may include, for example, a charged coupled device (CCD) or a complementary metal-oxide semiconductor (CMOS) device. The image sensor 16 may be monochromatic or color. The image sensor 16 generally has a small pixel size which is less than 9.0 μm in size and more particularly, smaller than 5.0 μm in size (e.g., 2.2 μm or smaller). Generally, image sensors 16 having smaller pixel size will produce higher resolutions. As explained herein, sub-pixel resolution can be obtained by using the method of capturing and processing multiple lower-resolution holograms, that are spatially shifted with respect to each other by sub-pixel pitch distances.

Still referring to FIG. 1A, the system 10 includes an illumination source 20 that is configured to illuminate a first side (top side as seen in FIG. 1A) of the sample holder 18. The illumination source 20 is preferably a spatially coherent or a partially coherent light source but may also include an incoherent light source. Light emitting diodes (LEDs) are one example of an illumination source 20. LEDs are relative inexpensive, durable, and have generally low power requirements. Of course, other light sources may also be used such as a Xenon lamp with a filter. A light bulb is also an option as the illumination source 20. A coherent beam of light such as a laser may also be used (e.g., laser diode). The illumination source 20 preferably has a spectral bandwidth that is between about 0.1 and about 100 nm, although the spectral bandwidth may be even smaller or larger. Further, the illumination source 20 may include at least partially coherent light having a spatial coherence diameter between about 0.1 to 10,000 μm.

The illumination source 20 may be coupled to an optical fiber as seen in FIG. 1A or another optical waveguide. If the illumination source 20 is a lamp or light bulb, it may be used in connection with an aperture 21 as seen in FIG. 1C that is subject to two-dimensional shifting or multiple apertures in the case of an array which acts as a spatial filter that is interposed between the illumination source 20 and the sample. The term optical waveguide as used herein refers to optical fibers, fiber-optic cables, integrated chip-scale waveguides, an array of apertures and the like. With respect to the optical fiber, the fiber includes an inner core with a higher refractive index than the outer surface so that light is guided therein. The optical fiber itself operates as a spatial filter. In this embodiment, the core of the optical fiber may have a diameter within the range of about 50 μm to about 100 μm. As seen in FIG. 1A, the distal end of the fiber optic cable illumination source 20 is located at a distance z₁ from the sample holder 18. The imaging plane of the image sensor 16 is located at a distance z₂ from the sample holder 18. In the system 10 described herein, z₂<<z₁. For example, the distance z₁ may be on the order of around 1 cm to around 10 cm. In other embodiments, the range may be smaller, for example, between around 5 cm to around 10 cm. The distance z₂ may be on the order of around 0.05 mm to 2 cm, however, in other embodiments this distance z₂ may be between around 1 mm to 2 mm. Of course, as described herein, the z₂ distance is adjustable in increments ranging from about 1 μm to about 1.0 cm although a larger range such as between 0.1 μm to about 10.0 cm is also contemplated. In other embodiments, the incremental z₂ adjustment is within the range of about 10 μm to about 100 μm. The particular amount of the increase or decrease does not need to be known in advance. In the system 10, the propagation distance z₁ is such that it allows for spatial coherence to develop at the plane of the object(s) 12, and light scattered by the object(s) 12 interferes with background light to form a lensfree in-line hologram on the image sensor 16.

Still referring to FIG. 1A, the system 10 includes a computer 30 such as a laptop, desktop, tablet, mobile communication device, personal digital assistant (PDA) or the like that is operatively connected to the system 10 such that lower resolution images (e.g., lower resolution or raw image frames) are transferred from the image sensor 16 to the computer 30 for data acquisition and image processing. The computer 30 includes one or more processors 32 that, as described herein in more detail, runs or executes software that takes multiple, sub-pixel (low resolution) images taken at different scan positions (e.g., x and y positions as seen in inset of FIG. 1A) and creates a single, high resolution projection hologram image of the objects 12. The software also digitally reconstructs complex projection images of the objects 12 through an iterative phase recovery process that rapidly merges all the captured holographic information to recover lost optical phase of each lensfree hologram. The phase of each lensfree hologram is recovered and one of the pixel super-resolved holograms is back propagated to the object plane to create phase and amplitude images of the objects 12. The reconstructed images can be displayed to the user on, for example, a display 34 or the like. The user may, for example, interface with the computer 30 via an input device 36 such as a keyboard or mouse to select different imaging planes.

FIG. 1A illustrates that in order to generate super-resolved images, a plurality of different lower resolution images are taken as the illumination source 20 is moved in small increments generally in the x and y directions. The x and y directions are generally in a plane parallel with the surface of the image sensor 16. Alternatively, the illumination source 20 may be moved along a surface that may be three-dimensional (e.g., a sphere or other 3D surface in the x, y, and z dimensions). Thus, the surface may be planar or three-dimensional. In one aspect of the invention, the illumination source 20 has the ability to move in the x and y directions as indicated by the arrows x and y in the inset of FIG. 1A. Any number of mechanical actuators may be used including, for example, a stepper motor, moveable stage, piezoelectric element, or solenoid. FIG. 1A illustrates a moveable stage 40 that is able to move the illumination source 20 in small displacements in both the x and y directions. Preferably, the moveable stage 40 can move in sub-micron increments thereby permitting images to be taken of the objects 12 at slight x and y displacements. The moveable stage 40 may be controlled in an automated (or even manual) manner by the computer 30 or a separate dedicated controller. In one alternative embodiment, the moveable stage 40 may move in three dimensions (x, y, and z or angled relative to image sensor 16), thereby permitting images to be taken of objects 12 at slight x, y, and z angled displacements.

In another alternative embodiment, rather than move the illumination source 20 in the x and y directions, a system may use a plurality of spaced apart illumination sources that can be selectively actuated to achieve the same result without having to physically move the illumination source 20 or image sensor 16. In this manner, the illumination source 20 is able to make relatively small displacement jogs (e.g., less than about 1 μm). The small discrete shifts parallel to the image sensor 16 are used to generate a single, high resolution image (e.g., pixel super-resolution). Details of such a fiber optic based device may be found in Bishara et al., “Holographic pixel super-resolution in portable lensless on-chip microscopy using a fiber-optic array,” Lab Chip 11, 1276 (2011).

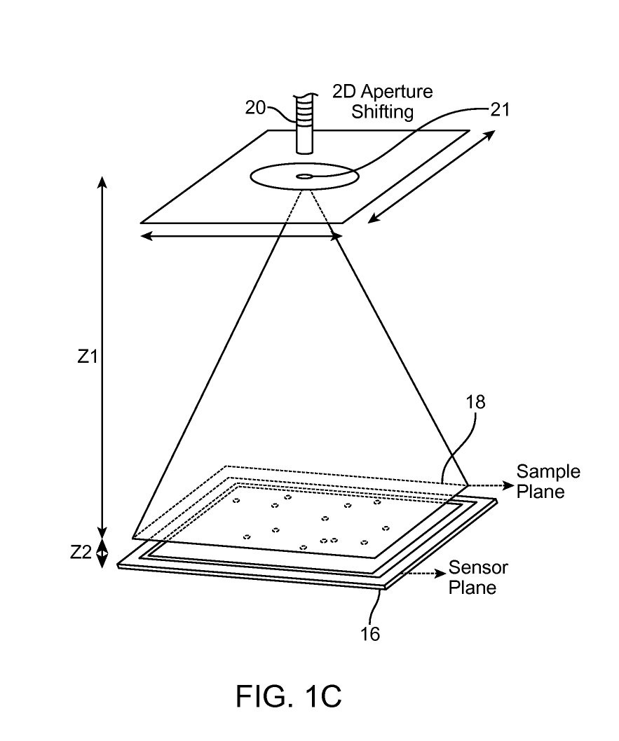

FIG. 2 illustrates a side view of a sample holder 18 in the form of a glass cover slip although other optically transparent substrates may be used. The size of the sample holder 18 is chosen based on the active imaging area of the image sensor 16. The sample holder 18 includes a highly hydrophilic surface on which the sample 14 is deposited. For example, if the sample holder 18 is glass it may be treated with a portable plasma generator for greater than about a minute to create a highly hydrophilic surface. As seen in FIG. 2, a wetting film monolayer 50 is formed on the sample holder 18. The wetting film monolayer 50 preferably is formed over the entire surface of the sample holder 18. The wetting film monolayer 50 contains therein randomly distributed objects 14.

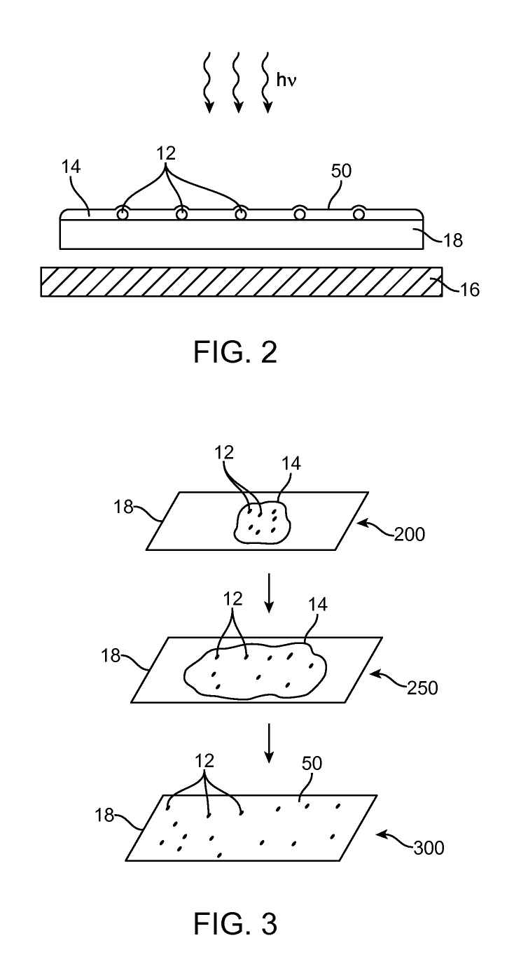

In order to create the wetting film monolayer 50 that contains the objects 12, the sample 14 is dissolved within a bio-compatible buffer in combination with a liquid polymer such as polyethylene glycol (PEG). As an example, the sample 14 may be dissolved in 0.1 M TRIS-HCL buffer with 5-10% PEG 600 (by weight). The amount of PEG may vary, for example, varying between 1-50% PEG by weight. The sample 14 contains the objects 12 that are to be imaged. These objects may be biological samples such as cells, organelles, bacteria, protozoa or they may be non-biological such as beads or the like. After dissolving the sample, the suspension is incubated at room temperature for thirty (30) seconds and sonicated for about two (2) minutes. A droplet (about μL) of this suspension is then placed onto the hydrophilic surface of the sample holder 18. This process is illustrated in step 200 of FIG. 3. Without any sedimentation period, the droplet now disposed on the sample holder 18 is mechanically vibrated (either manually or automatically via a vibrating mechanical stage as illustrated in step 250 of FIG. 3) until the droplet flow path covers the surface of the sample holder 18. This final process of wetting film formation is illustrated in step 300 of FIG. 3. For relatively larger-sized objects 12 (i.e., those objects 12 greater than 5 micrometers in diameter) the PEG % that is used is about 5% (by weight). This would include samples such as RBCs or parasites such as Giardia protozoa. For relatively smaller-sized objects 12 (i.e., those objects 12 smaller than 5 micrometers in diameter) the PEG % that is used is about 10% (by weight). This ensures the proper substrate-suspension interaction to create the ideal wetting film without any deformation on the objects 12.

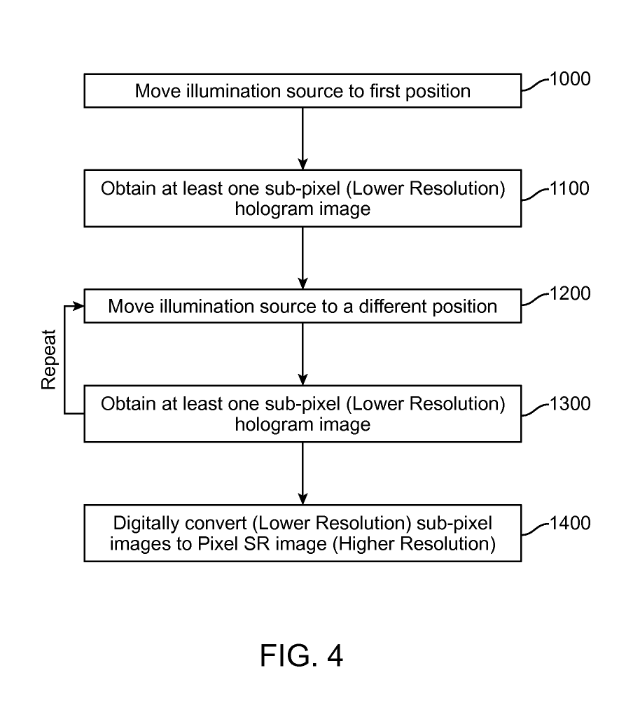

FIG. 4 illustrates a top-level flowchart of how the system 10 obtains higher resolution pixel Super Resolution (Pixel SR) images of objects 12 within a sample 14. After samples 14 are loaded into (or on) the sample holder 18, the illumination source 20 is moved to a first x, y position as seen in operation 1000. The illumination source 10 illuminates the sample 14 and a sub-pixel (LR) hologram image is obtained as seen in operation 1100. Next, as seen in operation 1200, the illumination source 10 is moved to another x, y position. At this different position, the illumination source 10 illuminates the sample 14 and a sub-pixel (LR) hologram image is obtained as seen in operation 1300. The illumination source 20 may then be moved again (as shown by Repeat arrow) to another x, y position where a sub-pixel (LR) hologram is obtained. This process may repeat itself any number of times so that images are obtained at a number of different x, y positions. Generally, movement of the illumination source 10 is done in repeated, incremental movements in the range of about 0.001 mm to about 500 mm.

In operation 1400, the sub-pixel (LR) images at each x, y position are digitally converted to a single, higher resolution Pixel SR image (higher resolution), using a pixel super-resolution technique, the details of which are disclosed in Bishara et al., Lensfree on-chip microscopy over a wide field-of-view using pixel super-resolution, Optics Express 18:11181-11191 (2010), which is incorporated by reference. First, the shifts between these holograms are estimated with a local-gradient based iterative algorithm. Once the shifts are estimated, a high resolution grid is iteratively calculated, which is compatible with all the measured shifted holograms. In these iterations, the cost function to minimize is chosen as the mean square error between the down-sampled versions of the high-resolution hologram and the corresponding sub-pixel shifted raw holograms. The conversion of the LR images to the Pixel SR image is preferably done digitally through one or more processors. For example, processor 32 of FIG. 1A may be used in this digital conversion process. Software that is stored in an associated storage device contains the instructions for computing the Pixel SR image from the LR images. To obtain a phase or amplitude image, a desired image plane is selected and back propagated to the object plane. This enables the one to extract the desired amplitude and/or phase reconstructed images of the objects 12 within the sample 14.

As explained herein, the use of the wetting film monolayer 50 significantly improves the imaging performance of the system 10 by creating an individual micro-lens over each object 12, which significantly improves the signal-to-noise ratio (SNR) and therefore the resolution quality of the images. This improved resolution, when combined with obtaining higher resolution Pixel SR images enables lens-free imaging of objects 12 having fine morphological features (e.g., features with dimensions on the order of around 0.5 μm) such as Escherichia coli (E. coli), human sperm, Giardia lamblia trophozoites, polystyrene micro beads as well as blood cells such as RBCs. These results are especially important for field-portable microscopic analysis tools.

### Experimental

For imaging experiments a quasi-monochromatic light source (500 nm center wavelength; ˜5 nm bandwidth; Cornerstone T260, Newport Corp., USA) was used that emanated from a large aperture of ˜100 μm diameter located at z₁=10 cm above the digital sensor array (CMOS—Aptina MT9P031I12STM). The samples to be imaged were located typically at z₂<1-2 mm from the active surface of the CMOS sensor-array having an active imaging area of about 24 mm².

In order to mitigate SNR-related limitations in partially coherent lensfree on-chip microscopy, an ultra-thin wetting film was used which effectively acts as micro-lens over individual objects within the sample, and therefore enables significant SNR and contrast enhancement for microscopic imaging of fine spatial features of objects. Wetting film formation protocol described below is controllable and repeatable; and is therefore quite promising for practical implementations of this microscopy platform—even in field settings.

Prior to preparation of wetting films, samples of interest (which were obtained from vendors or cultured in laboratory conditions) were brought to room temperature. Giardia lamblia trophozoites were fixed in 5% Formalin at pH 7.4-0.01% TWEEN 20 (Waterborne Inc., USA) and dissolved in Phosphate buffered saline (PBS). For the particular case of trophozoites, zinc-free pure New Methylene Blue dye (Acros Organics) that is purified with 0.45 μm pore size Syringless Filter (Whatman) was for the aqueous staining of the parasites. Frozen semen samples (California Cyrobank, USA) were thawed in 37° C. water bath for ten (10) minutes and then diluted with sperm washing medium (Irvine Scientific, USA). Whole blood samples (UCLA Blood Bank, USA) were incubated in room conditions for thirty (30) minutes to acquire sedimented RBCs. Polystyrene beads were purchased from Thermo Scientific and E. coli specimens were cultured in UCLA Biomedical Engineering facility.

In order to form wetting films, the sample of interest is initially dissolved and agitated within 0.1 M Tris-HCl—10% PEG 600 buffer (Sigma Aldrich) and is incubated for thirty (30) seconds at room temperature. Using a lab pipette, a droplet of the resulting suspension (˜5 μL) was placed onto a No. glass cover slip (Fisher Scientific, USA) which was previously cleaned using a plasma cleaner (Harrick Plasma). Then, the droplet is wiggled over the cover slip by gentle mechanical vibration for around sixty (60) seconds, forming the thin wetting film over the specimen. This vibration can be generated by hand for better control of the droplet movement. Alternatively, the vibration can be generated by a mechanical vibrator or the like. It is also important to note that this procedure does not require the precise control of the droplet volume, as the wetting film spread can be easily adjusted depending on the imaging area of the CMOS sensor-array.

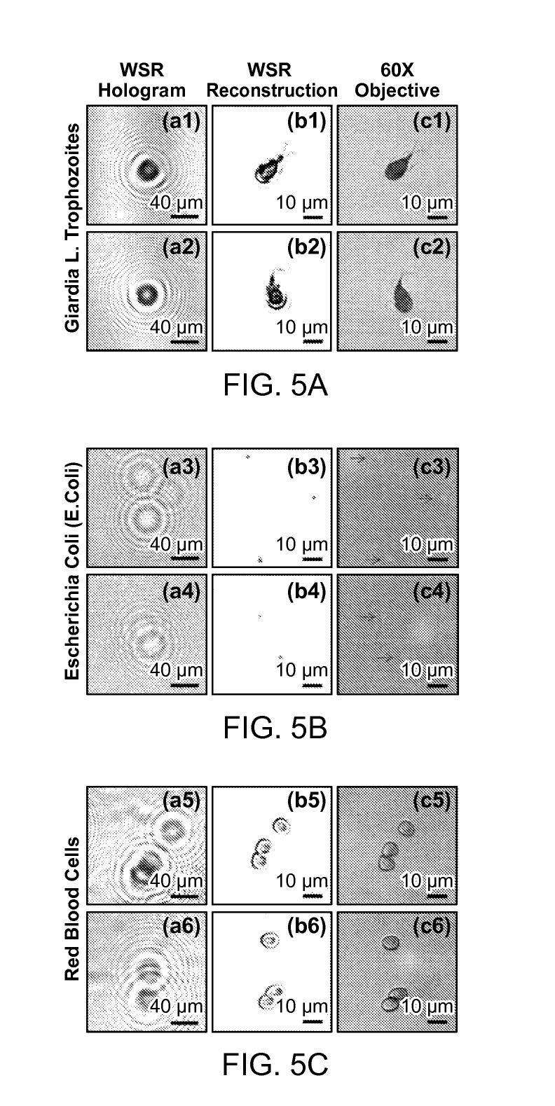

FIGS. 5A, 5B, and 5C illustrate the improved imaging performance as a result of the use of wetting films to image Giardia lamblia trophozoites, E. Coli, and human RBCs. FIG. 5A illustrates in images (a1) and (a2) digital hologram images of Giardia lamblia trophozoites using a wetting film. FIG. 5A illustrates in images (b1) and (b2) reconstructed microscope images of the Giardia lamblia trophozoites. Through the micro-lens effect of the wetting films, the contrast and SNR of the digital holograms of weakly scattering features are revealed in the reconstructed images. For example, the flagella of the Giardia lamblia trophozoites can be seen in images (b1) and (b2) of FIG. 5A. Images (c1) and (c2) of FIG. 5A illustrates corresponding 60× objective lens (NA=0.85) images.

FIG. 5B illustrates in images (a3) and (a4) digital hologram images of E. coli using a wetting film. FIG. 5B illustrates in images (b3) and (b4) reconstructed microscope images of E. coli. Images (c3) and (c4) of FIG. 5B illustrates corresponding 60× objective lens (NA=0.85) images. Note that the bright-field transmission microscope images of E. coli samples (images (c3) and (c4)) were particularly faint (even using a 0.85 NA objective-lens) due to their sub-micrometer structure; and therefore arrows point to their locations as seen in images (c3) and (c4). The same E. coli samples, however, were imaged with a rather strong contrast using the wetting-film based lensfree holographic microscope as illustrated in images (b3) and (b4) of FIG. 5B. This relative contrast improvement compared to a regular bright-field microscope is expected since lensfree in-line holography effectively behaves like a phase contrast microscope by indirectly detecting the optical phase information of the specimens in the form of holographic intensity fringes.

FIG. 5C illustrates in images (a5) and (a6) digital hologram images of RBCs using a wetting film. FIG. 5C illustrates in images (b5) and (b6) reconstructed microscope images of the RBCs. Through the micro-lens effect of the wetting films, the contrast and SNR of the digital holograms of weakly scattering features are revealed in the reconstructed images. For example, the unique doughnuts-shape of the RBCs can be seen in images (b5) and (b6) of FIG. 5C. Images (c5) and (c6) of FIG. 5C illustrates corresponding 60× objective lens (NA=0.85) images.

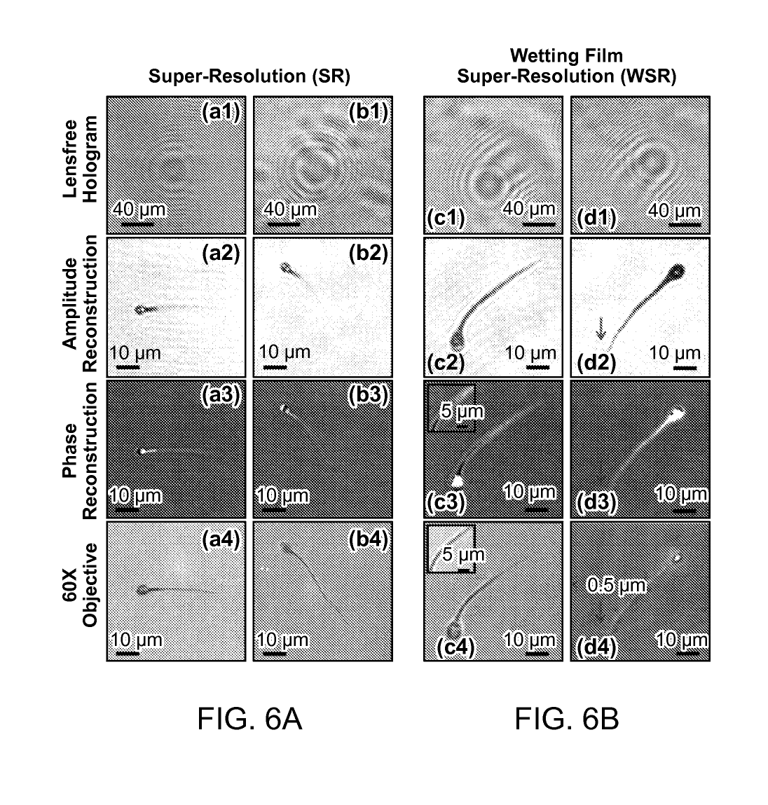

Next, to provide a better comparison of the wetting film and its effect on imaging quality, experiments were conducted on sperm smears that were imaged using lensless pixel super-resolution microscopy with and without the formation of a wetting film. The results of this comparison can be seen in the panel of images of FIGS. 6A and 6B. FIG. 6A reflect various images obtained without a wetting film while FIG. 6B reflect various images obtained with a wetting film. Images (a1) and (b1) of FIG. 6A illustrate the lens free hologram images of sperm taken without the use of any wetting film. Images (c1) and (d1) of FIG. 6B illustrate the lens free hologram images of sperm taken with the use of any wetting film. Images (a2) and (b2) of FIG. 6A illustrate the amplitude reconstruction of sperm taken without the use of any wetting film. Images (c2) and (d2) of FIG. 6B illustrate the amplitude reconstruction of sperm taken with the use of any wetting film. Images (a3) and (b3) of FIG. 6A illustrate the phase reconstruction of sperm taken without the use of any wetting film. Images (c3) and (d3) of FIG. 6B illustrate the phase reconstruction of sperm taken with the use of any wetting film. Images (a4) and (b4) of FIG. 6A illustrate microscope images (60×) of sperm taken without the use of a wetting film. Images (c4) and (d4) of FIG. 6B illustrate microscope images (60×) of sperm taken with the use of a wetting film.

Without the wetting film, lensfree holograms of sperm samples did not show a major asymmetry in their fringe patterns as seen in images (a1) and (b1) of FIG. 6A, which is due to the weaker scattering cross-sections of their tails compared to the sperm head. Conversely, with the formation of the thin wetting film around the sperms, textural asymmetry was observed on the lensfree sperm holograms as seen in images (c1) and (d1) of FIG. 6B which reveals the elongated holographic signatures of sperm tails due to the presence of the thin wetting film. The same conclusion was also supported in the reconstructed images as seen in images (c2) and (d2) of FIG. 6B such that with the wetting film the fine morphological features of the sperm tails became much more visible compared to a regular smear without the wetting film (compared to images (a2) and (b2) of FIG. 6A. As an example, the end of the sperm tail shown in image (d4) of FIG. 6B with an arrow measures <0.5 μm in width, which was faithfully imaged using the wetting film based lensless holographic microscope as illustrated in images (d2) and (d3) of FIG. 6B. Although the refractive index difference between the sperm tails and the surrounding medium created a sufficient contrast in the reconstructed phase images for both of the cases (i.e., with or without the use of the wetting film), phase as well as amplitude images of wetting samples were comparatively much better resolved as illustrated in FIG. 6B. The physical existence of the wetting film over the sperm samples was further validated in the phase reconstruction results, showing the tail structure recovered inside the wetting film (see e.g., the digitally zoomed region of interest in image (c3) of FIG. 6B (inset)). The same behavior can be also seen in the corresponding 60× objective-lens image as illustrated in image (c4) of FIG. 6B and its inset.

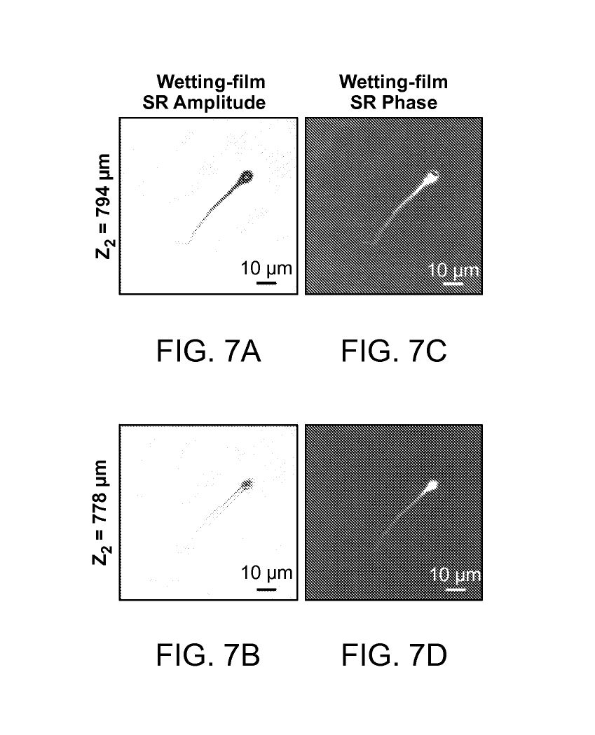

An important feature of lensfree holographic microscopy is that by digitally changing the focusing distance (i.e., z₂) different depths within the sample volume can be reconstructed. This feature is illustrated in FIGS. 7A-7D, where for the same sperm sample shown in FIG. 6B images (d2) and (d3), two different reconstruction planes are shown corresponding to z₂=794 μm and z₂=778 μm. Notice that since the wetting film induced micro-lens behaves physically different for the tail and the head of the sperm (due to significant differences in their morphology and size), as expected the tail and the head are seen to get in focus at different reconstruction planes (e.g., the tail is in focus at z₂=794 μm (FIGS. 7A and 7C) whereas the head gets in focus at z₂=778 μm as illustrated in FIGS. 7B and 7D).

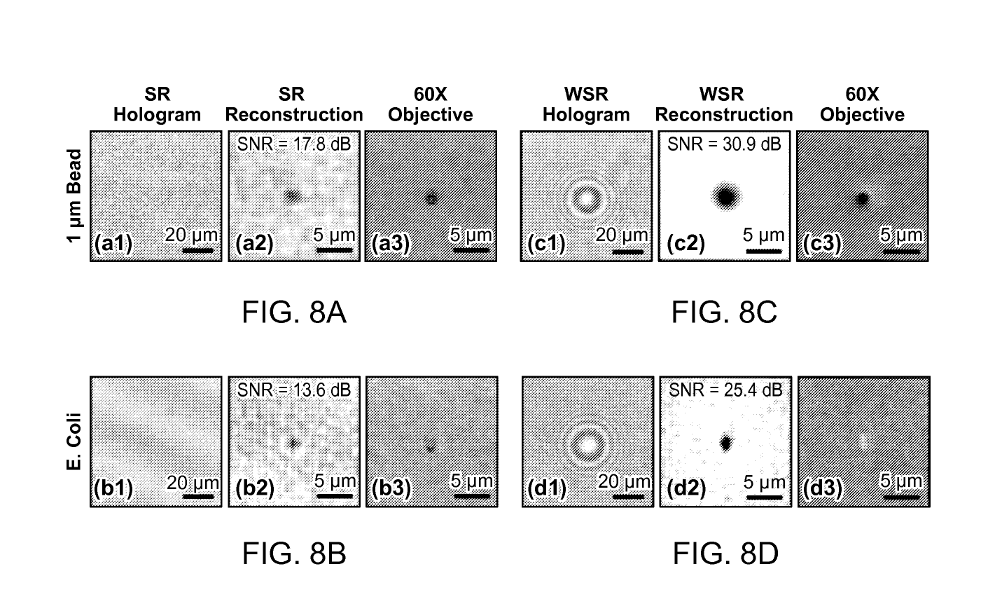

In order to further investigate the performance improvement of the lensfree microscopy platform due to the presence of the thin wetting films, a polystyrene bead of 1 μm diameter was imaged as well as an E. coli containing-sample as seen in FIGS. 8A-8D. Image (a1) of FIG. 8A is a Super Resolution hologram image of a 1 μm diameter bead. Image (a2) of FIG. 8A is a Super Resolution reconstruction image of a 1 μm diameter bead (SNR=17.8 dB). Image (a3) of FIG. 8A is a corresponding microscope image taken with a 60× objective lens. Image (b1) of FIG. 8B is a Super Resolution hologram image of a bacterium (E. coli). Image (b2) of FIG. 8B is a Super Resolution reconstruction image of the bacterium (SNR=13.6 dB). Image (b3) of FIG. 8B is a corresponding microscope image taken with a 60× objective lens. Image (c1) of FIG. 8C is a Wetting film Super Resolution hologram image of a 1 μm diameter bead obtained with a wetting film. Image (c2) of FIG. 8C is a Wetting Super Resolution reconstruction image of the 1 μm diameter bead (SNR=30.9 dB) obtained with a wetting film. Image (c3) of FIG. 8C is a corresponding microscope image taken with a 60× objective lens.

First, without the wetting film, the lensfree super-resolved holograms of these objects did not reveal any “visible” holographic signatures as illustrated in images (a1) and (b1) of FIGS. 8A and 8B. Despite this fact, their respective reconstructed holographic images still revealed the weak signatures of these objects as illustrated in images (a2) and (b2) of FIGS. 8A and 8B. With the use of the wetting film, however, the lensfree super-resolved holograms of these particles showed a significant SNR improvement as illustrated in image (c1) of FIG. 8C and image (d1) of FIG. 8D, where the interference fringes are rather strong and are visible to bare eye, unlike images (a1) of FIG. 8A and image (b1) of FIG. 8B. These improved holographic signatures then translated into much better reconstructed microscopic images as shown in image (c2) of FIG. 8C and image (d2) of FIG. 8D. These results demonstrated a significant SNR enhancement of up to ˜74% and ˜87% in dB (corresponding to ˜352% and ˜289% in linear scale) on lensfree amplitude reconstruction images of 1 μm bead and E. coli, respectively. These digital SNR values were calculated using the formula:

SNR=20 log₁₀|(max (I)−μ₀)/σ₀| (Eq. 1)

where I is the intensity of the reconstructed image, and μ₀ and σ₀ are the mean and the variance of the background noise region, respectively. Note also that the wetting film based lensfree reconstructed image of E. coli (image (d2) of FIG. 8D) shows not only a higher contrast and SNR but also the elongated rod-shaped structure of the bacteria is more visible with the wetting film compared to the reconstruction results without the wetting film (image (b2) of FIG. 8B). Moreover, 60× bright-field microscope comparison images are again quite faint (see e.g., image (d3) of FIG. 8D) compared to the holographic reconstruction results.

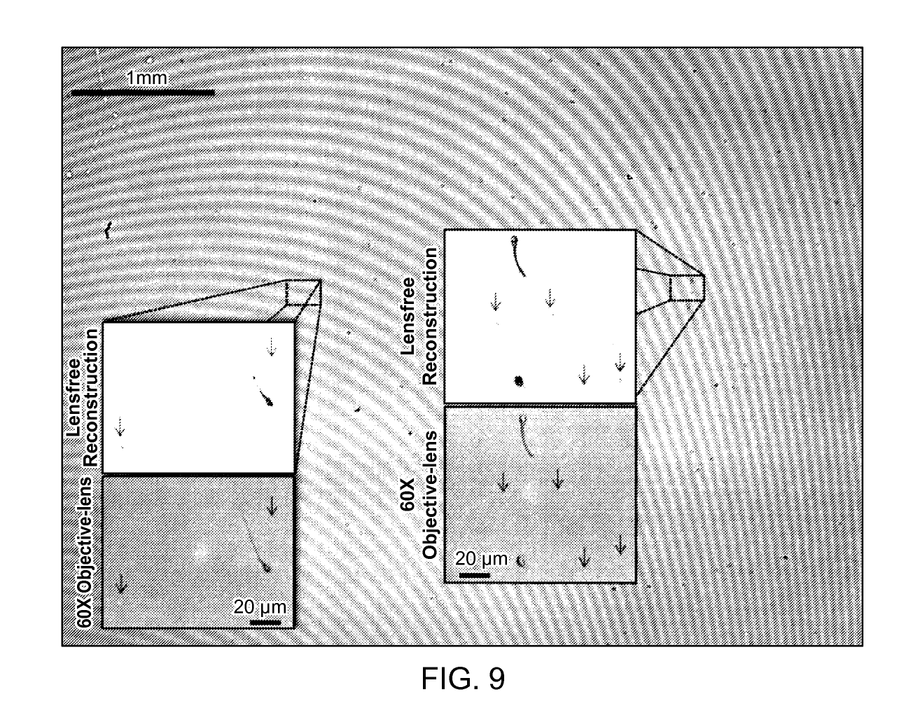

Finally, a full field-of-view (i.e., 24 mm²) lensfree holographic image of a spiked wetting film sample that is composed of Giardia lamblia trophozoites, E. coli and sperm samples is illustrated in FIG. 9 in order to demonstrate the wide imaging area of the on-chip microscopy platform. E. coli bacteria are identified by the arrows. Lensfree reconstruction images (zoomed) are shown in inset along with a comparative 60× microscope objective lens image (0.85 NA). This constitutes >100 fold larger FOV, when compared to a bright-field optical microscope using e.g., a 40× objective-lens. Considering the additional contrast and SNR improvements due to the micro-lens effect of the wetting films, such a high-throughput and high-resolution microscopy platform can be very useful to rapidly evaluate e.g., bodily fluids or water samples even in remote locations or field settings. Moreover, the wetting film formation procedure described here is rather repeatable which makes it applicable even in resource limited environments with relatively low level of training.

Significant improvement is thus seen in the performance of lensfree on-chip super-resolution microscopy due to wetting film induced micro-lens effect by imaging various micro-objects such as Giardia lamblia trophozoites, human sperm, polystyrene beads, E. coli as well as RBCs. Experimental results yielded up to four-fold SNR improvement, showing better recovery of sub-micron features of specimens such as sperm tails and flagella of Giardia lamblia parasites. This wetting film approach allows a stable and repeatable micro-lens effect on individual objects to enhance the capabilities of our field-portable lensfree holographic microscopes. Therefore, it may provide a quantitative toolset to carry out highly-sensitive measurements even in resource-limited environments without the need for advanced sample preparation procedures.

Importantly, the method of preparing the monolayer wetting film is not evaporation based and does not require any particular equipment such as specialized temperature controllers or the like. The method can be performed without the aid of specialized equipment necessary to control evaporation conditions. The monolayer wetting film can be created at room temperature conditions and is stable and reproducible without the need of any expensive and cumbersome equipment. Because the method is fully controllable and independent of environmental conditions it is well suited for in-the-field applications.

While one of the methods described herein uses a plurality of lower resolution images of a sample that are then converted to a higher resolution, it should be understood that as one alternative embodiment of the invention, a lower resolution image of the sample may be sufficient. Such an option might be favored if the objects being imaged are large or fine detail in the image is not needed. Likewise, if speed or throughput is favored, there may be no need for the extra processing steps required to generate a pixel SR image. In such an embodiment, the method of imaging a sample includes forming a monolayer wetting layer over a sample containing objects therein (as previously described with respect to the prior embodiments); interposing the sample between an illumination source and an image sensor; illuminating the sample with the illumination source; and obtaining an image of the sample with the image sensor.

While the invention described herein has largely been described as a “lens free” imaging platform, it should be understood that various optical components, including lenses, may be combined or utilized in the systems and methods described herein. For instance, the devices described herein may use small lens arrays (e.g., micro-lens arrays) for non-imaging purposes. As one example, a lens array could be used to increase the efficiency of light collection for the sensor array. Such optical components, while not necessary to image the sample and provide useful data and results regarding the same may still be employed and fall within the scope of the invention. While embodiments of the present invention have been shown and described, various modifications may be made without departing from the scope of the present invention. The invention, therefore, should not be limited, except to the following claims, and their equivalents.

1. A method of imaging a sample comprising:
forming a monolayer wetting layer over a sample containing objects therein;
obtaining a plurality of lower resolution images of sample interposed between an illumination source and an image sensor, wherein each lower resolution image is obtained at discrete spatial locations;
converting the plurality of lower resolution images of the sample into a higher resolution image; and
reconstructing at least one of an amplitude image and a phase image of the objects contained within the sample.

2. The method of claim 1, wherein the objects contained in the sample comprise cells.

3. The method of claim 2, wherein the cells comprise sperm cells or blood cells.

4. (canceled)

5. The method of claim 1, wherein the objects comprise protozoa, bacteria, or viruses.

6-7. (canceled)

8. The method of claim 1, wherein the objects comprise particles having a size within the range of about 0.05 μm to about 500 μm.

9. The method of claim 1, wherein forming the monolayer wetting layer comprises vibrating the sample.

10. The method of claim 9, wherein vibration of the sample comprises manually shaking the sample disposed on a sample holder.

11. The method of claim 1, wherein forming the monolayer wetting layer comprises dissolving the sample in a liquid polymer.

12. The method of claim 1, wherein forming the monolayer wetting layer comprises dissolving the sample in polyethylene glycol (PEG).

13. The method of claim 12, wherein the sample is dissolved in a buffer along with between 1-50% PEG (by weight).

14. A method of imaging a sample comprising:
forming a monolayer wetting layer over a sample containing objects therein;
interposing the sample between an illumination source and an image sensor;
illuminating the sample with the illumination source; and
obtaining an image of the sample with the image sensor.

15. The method of claim 14, wherein the objects contained in the sample comprise cells.

16. The method of claim 15, wherein the cells comprise sperm cells or blood cells.

17. (canceled)

18. The method of claim 14, wherein the objects comprise protozoa, bacteria, or viruses.

19-20. (canceled)

21. The method of claim 14, wherein the objects comprise particles having a size within the range of about 0.05 μm to about 500 μm.

22. The method of claim 14, wherein forming the monolayer wetting layer comprises vibrating the sample.

23. The method of claim 22, wherein vibration of the sample comprises manually shaking the sample disposed on a sample holder.

24. The method of claim 14, wherein forming the monolayer wetting layer comprises dissolving the sample in a liquid polymer.

25. The method of claim 14, wherein forming the monolayer wetting layer comprises dissolving the sample in polyethylene glycol (PEG).

26. The method of claim 25, wherein the sample is dissolved in a buffer along with between 1-50% PEG (by weight).
